(19) United States
(12) Patent Application Publication
(10) Pub. No.: US 2020/0141732 A1
(43) Pub. Date: May 7, 2020

(54) MULTI-AXIS GYROSCOPE WITH REDUCED BIAS DRIFT

(71) Applicant: SEMICONDUCTOR COMPONENTS INDUSTRIES, LLC, Phoenix, AZ (US)

(72) Inventors: Cenk ACAR, Santa Clara, CA (US); Brenton SIMON, Fremont, CA (US); Sandipan MAITY, San Carlos, CA (US)

(73) Assignee: SEMICONDUCTOR COMPONENTS INDUSTRIES, LLC, Phoenix, AZ (US)

(21) Appl. No.: 16/179,599

(22) Filed: Nov. 2, 2018

(51) Int. Cl. G01C 19/574; G01P 15/125

(52) U.S. Cl. CPC G01C 19/574; G01P 15/125

(57) ABSTRACT

A micromachined gyroscope includes a dynamic mass suspended from at least one anchor attached to a substrate. The dynamic mass includes a first proof mass and a second proof mass, a first drive actuator configured to drive the first proof mass in a first direction in a rotary oscillation mode of the gyroscope, and second drive actuator configured to drive the second proof mass in an opposite direction in the rotary oscillation mode of the gyroscope.

### TECHNICAL FIELD

The present disclosure relates to micro machined multi-axis gyroscopes.

### BACKGROUND

A micromachined gyroscope is a type of inertial sensor which can be used to measure angular rate. Several single-axis or multi-axis micromachined microelectromechanical systems (MEMS) gyroscopes have been integrated into various systems, such as but not limited to smartphones, wearable electronics systems, augmented reality virtual reality devices, gaming consoles, drones, etc.. However, output bias drift can affect accuracy and precision of the information generated by the MEMS gyroscope. A principal source of such a bias drift is actuation of sense modes by energy leakage from the drive motion of the gyroscope.

### BRIEF DESCRIPTION OF THE DRAWINGS

FIG. 1 illustrates a 3-degrees-of-freedom (3-DOF) inertial measurement unit (IMU).

FIG. 2 illustrates an example gyroscope that has a first dynamic mass configuration with two proof masses.

FIG. 3 illustrates views of anchor suspension flexures and central suspension flexures in the gyroscope of FIG. 2.

FIG. 4 illustrates a first state of counter clockwise rotation of the first proof mass and clockwise rotation of the second proof mass in the gyroscope of FIG. 2.

FIG. 5 illustrates a second state of clockwise rotation of the first proof mass and a counter clockwise rotation of the second proof mass in the gyroscope of FIG. 2.

FIG. 6 illustrates compressive motion of the gyroscope of FIG. 2 driven by Z-axis rate sense electrodes to sense the Coriolis rate response.

FIG. 7 illustrates expansive motion of the gyroscope of FIG. 2 driven by Z-axis rate sense electrodes to sense the Coriolis rate response.

FIGS. 8 and 9 illustrate an example of the motion of the gyroscope of FIG. 2 driven by X-axis rate sense electrodes and driven by Y-axis rate sense electrodes, respectively, to sense the Coriolis rate response.

FIG. 10 illustrates a tilt displacement of the gyroscope of FIG. 2 driven by X-axis rate sense electrodes to sense the Coriolis rate response.

FIG. 11 illustrates an example gyroscope that has a second dynamic mass configuration with two proof masses and sense nodes on only one of the two proof masses.

FIG. 12 illustrates a first state of clockwise rotation of an inner proof mass and counter-clockwise rotation of an outer proof mass in the gyroscope of FIG. 11.

FIG. 13 illustrates a second state of counter-clockwise rotation of the inner proof mass and clockwise rotation of the outer proof mass in the gyroscope of FIG. 11.

FIG. 14 illustrates an example gyroscope that has a third dynamic mass configuration including four independent proof masses.

FIG. 15 illustrates a first state of rotations of the four independent proof masses in the gyroscope of FIG. 14.

FIG. 16 illustrates a second state of rotations of the four independent proof masses in the gyroscope of FIG. 14.

FIG. 17 illustrates an example gyroscope that has a fourth dynamic mass configuration including four independent proof masses.

FIG. 18 illustrates an example method for balancing angular momentum of proof masses in a gyroscope.

### DETAILED DESCRIPTION

Micromachined gyroscopes can include mechanical components that can be made of silicon. These mechanical structures may include components that have dimensions on the order of a few to tens of microns thick. Commonly, micromachined gyroscopes are enclosed in MEMS packages, which can be fabricated using, for example, off-the-shelf packaging techniques and material derived from the semiconductor microelectronics field. A MEMS package may provide, for example, some mechanical support, protection from the environment, and electrical connection to other system components. However, a MEMS package may be subject to mechanical and or thermal stress, which can propagate to and warp an enclosed gyroscope substrate and/or its components. Such packaging induced stress or substrate stress induced deformation of gyroscope components remains a concern (e.g., for high performance gyroscopes) since it can directly affect the performance of the enclosed micromachined gyroscope in operation.

A source of output bias drift in an enclosed micromachined gyroscope is actuation of the sense modes by energy leakage from the drive motion in the enclosed micromachined gyroscope. This energy can propagate in the form of stress waves into the substrate and the package, and subsequently into the printed circuit board (PCB), interact with, and reflect from its surroundings, then return to the gyroscope and produce a response within the sense modes. This response may be detected as an output bias. The bias is vulnerable to changes in the PCB, intermittent contacts, and varying thermal and stress conditions.

This disclosure is directed to example micromachined, multi-axis gyroscope structures (e.g., formed in an x-y plane of a device layer) that can have torsional drive motions of proof masses that are balanced in angular momentum. The balancing of angular momentum of the drive motions reduces the leakage of drive energy into the substrate and hence reduces the reflection from surroundings and subsequently lowers the output bias drift. The balancing of angular momentum of the drive motions can be accomplished by balancing opposing proof mass motions in different proof mass arrangements for the gyroscope configurations described below.

In an example, a 3-axis gyroscope may have a single planar proof mass design providing 3-axis gyroscope operational modes. The planar proof-mass in the device layer can be symmetrically suspended from a substrate (or anchored to a substrate) using a configuration of geometrically-distributed anchors and one or more symmetrical flexure bearings (which can be referred to as flexures), such as in accordance with the principles of the present disclosure. In an example implementation the planar proof-mass is suspended from a set of four anchors attached to the substrate. Further, the flexures can include X, Y, and Z-axis flexure bearings.

Such multiple geometrically-distributed anchors can track substrate deformation and can physically modify the out-of-plane capacitive gaps of measurement electrodes in the gyroscope that measure X-axis and Y-axis rates (angular velocities) of the proof mass to compensate for the substrate deformation. For example, the out-of-plane capacitive gaps of the electrodes can be averaged across two anchors in each of the X and Y dimensions.

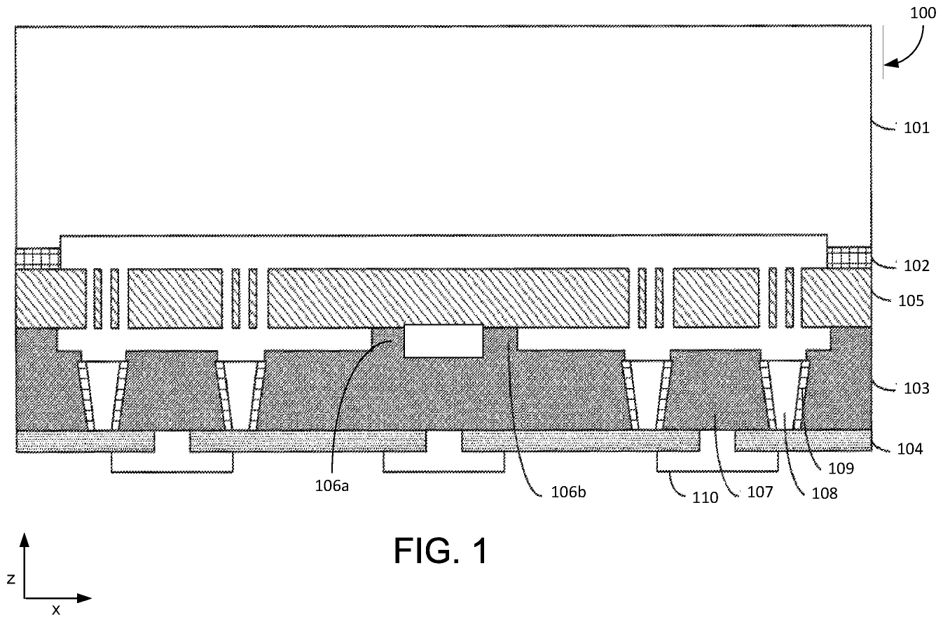

FIG. 1 is a schematic cross-sectional view of a 3-degrees-of-freedom (3-DOF) inertial measurement unit (IMU) 100, in accordance with the principles of the present disclosure.

IMU 100 includes a 3-DOF gyroscope or a 3-DOF micromachined accelerometer, formed in a chip-scale package including a cap wafer 101, a device layer 105 including micromachined structures (e.g., a micromachined 3-DOF IMU), and a substrate or via wafer 103. Device layer 105 can be sandwiched between cap wafer 101 and via wafer 103, and the cavity between device layer 105 and cap wafer 101 can be sealed under vacuum at the wafer level.

In an example, cap wafer 101 can be bonded to the device layer 105 using, for example, a metal bond 102. Metal bond 102 can include a fusion bond, such as a non-high temperature fusion bond, to allow getter to maintain long term vacuum and application of anti-stiction coating to prevent stiction that can occur in low-g acceleration sensors. In an example, during operation of device layer 105, metal bond 102 can generate thermal stress between cap wafer 101 and device layer 105. In some examples, one or more features can be added to device layer 105 to isolate the micromachined structures in the device layer 105 from thermal stress, such as one or more stress reducing grooves formed around the perimeter of the micromachined structures. In an example, via wafer 103 can be bonded to device layer 105 (e.g., silicon-silicon fusion bonded, etc.) to obviate thermal stress between via wafer 103 and device layer 105.

In an example, via wafer 103 can include one or more isolated regions, such as a first isolated region 107, isolated from one or more other regions of via wafer 103, for example, using one or more through-silicon-vias (TSVs), such as a first TSV 108 insulated from via wafer 103 using a dielectric material 109. In certain examples, the one or more isolated regions can be utilized as electrodes to sense or actuate out-of-plane operation modes of the 3-axis inertial sensor, and the one or more TSVs can be configured to provide electrical connections from device layer 105 outside of IMU 100. Further, via wafer 103 can include one or more contacts, such as a first contact 110, selectively isolated from one or more portions of via wafer 103 using a dielectric layer 104 and configured to provide an electrical connection between one or more of the isolated regions or TSVs of via wafer 103 to one or more external components, such as an ASIC wafer, using bumps, wire bonds, or one or more other electrical connections.

In accordance with the principles of the present disclosure, a 3-degrees-of-freedom (3-DOF) gyroscope or the micromachined accelerometer in device layer 105 can be supported or anchored to via wafer 103 by bonding device layer 105 to a plurality of protruding portions of via wafer 103, such as anchor 106a and anchor 106b shown in the cross sectional view of FIG. 1. The plurality of protruding portions of via wafer 103 (e.g., anchor 106a and anchor 106b) can be located at a substantial distance from the center of the via wafer 103, and device layer 105 can, for example, be fusion bonded to the anchor 106a and anchor 106b (e.g., to eliminate, or reduce problems associated with metal fatigue).

In an example implementation, four off-center anchors can be symmetrically located at corners of a geometrical square (e.g., with each anchor being at a same radial distance from the center of the square) to support the gyroscope or the micromachined accelerometer in device layer 105 on the via wafer 103. The four off- center anchors may include the two anchors (e.g., anchor 106a and anchor 106b) seen in the cross sectional view of FIG. 1, and two anchors (not shown) that are in a plane perpendicular to FIG. 1.

The 3-degrees-of-freedom (3-DOF) gyroscope structures described herein can have two masses in the X-Y plane: a dynamic mass, which can be driven to resonance (e.g., by drive electrodes), and a static mass, which can serve as a platform. The dynamic mass can be connected to the static mass, and the static mass can be connected to the substrate. The platform can be anchored to the substrate at four locations of the symmetrically placed four off-center anchors. The suspension of the platform and connected dynamic mass from the geometrically distributed four anchors can effectively average the out-of-plane displacement of the dynamic mass with respect to stress-induced substrate warpage or bending of the substrate across these four locations, thus reducing asymmetric gap changes due to stress.

The 3-degrees-of-freedom (3-DOF) gyroscope in device layer 105 may be implemented with different dynamic mass configurations in device layer 105. Each dynamic mass configuration described herein includes a plurality of proof masses that are arranged to create a rotary oscillatory drive motion that is balanced in angular momentum, in accordance with the principles of the present disclosure.

In a first dynamic mass configuration, the dynamic mass includes two proof masses with sense nodes on each of the two proof masses. A second dynamic mass configuration, like the first dynamic mass configuration, includes two proof masses. However, in the second dynamic mass configuration, there are sense nodes only on one of the two proof masses. In a third dynamic mass configuration, there are four independent proof masses. In a fourth dynamic mass configuration, like the third dynamic mass configuration, there are there are four independent proof masses that are further held together by an outer ring. The outer ring adds inertia to each of the four independent proof masses. In all of the four dynamic mass configurations described herein, the plurality of proof masses can be arranged to balance angular momentums of drive motions of the proof masses.

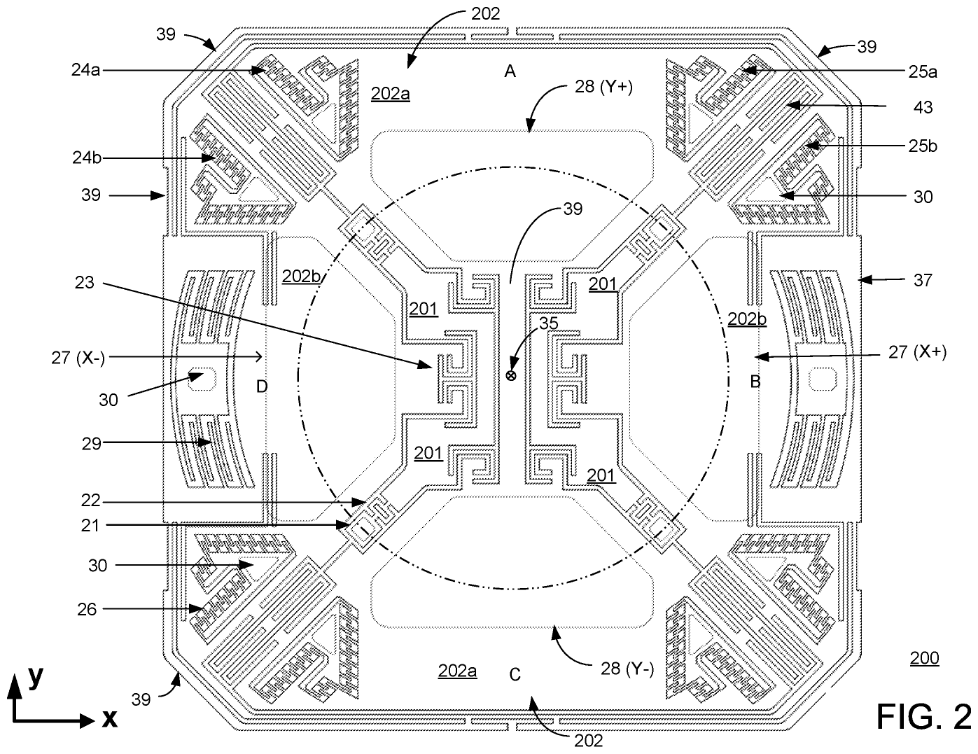

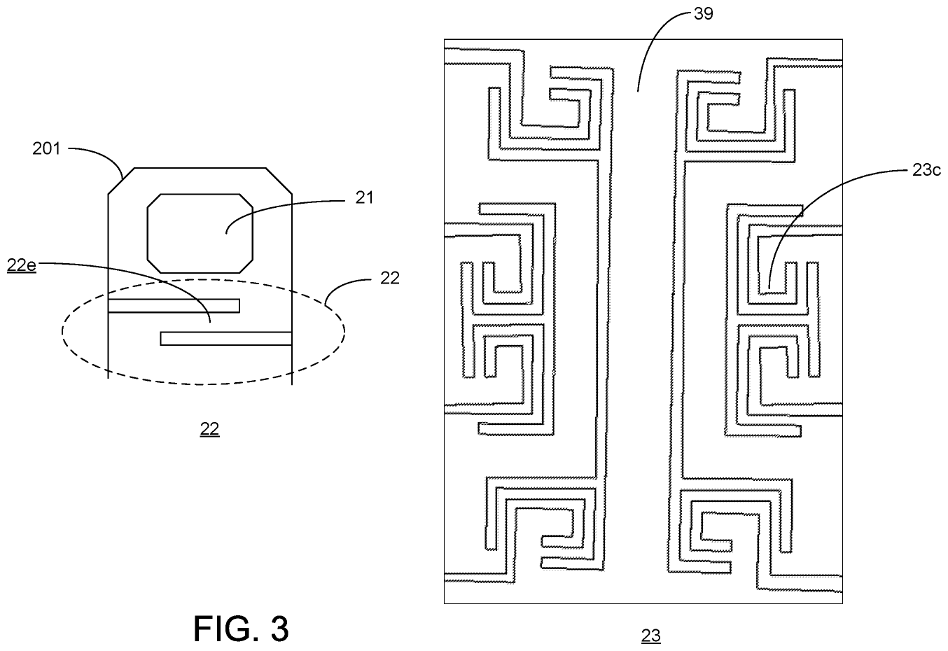

FIG. 2 shows an example gyroscope 200 that has a first dynamic mass configuration with two proof masses, in accordance with the principles of the present disclosure. FIG. 3 shows exploded views of example anchor suspension flexures and example central suspension flexures that can be used in example gyroscope 200.

Gyroscope 200, which may be fabricated in a device layer (e.g., device layer 105, FIG. 1), includes a static mass 201 and a dynamic mass 202 (including proof mass 202a and proof mass 202b) in the X-Y plane.

Static mass 201, which may have an X shape (a cross shape) is supported on the substrate (e.g., wafer 103) by four off-center anchors (e.g., anchors 21) via anchor suspension flexures (e.g., flexure 22). In example implementations, flexure 22 may include one or more rectangular elastic hinges 22e (e.g., as shown in FIG. 3).

In the gyroscope 200, dynamic mass 202 is suspended around static mass 201 via gyroscope central suspension flexures 23. Gyroscope central suspension flexures 23, which may be C-beam flexures, attach dynamic mass 202 to static mass 201 at about the bottoms of the four valleys of the X-shape of static mass 201. In example implementations, gyroscope central suspension flexures 23 may include one or more C-shape spring-like elements (e.g., C-beam flexures 23c) (FIG. 3).

Dynamic mass 202 can include two proof masses 202a and 202b distributed over four quadrants (A, B, C, and D) of the gyroscope 200. Proof mass 202a may be distributed over, for example, opposing quadrants A and C with portions (halves) of proof mass 202a corresponding to quadrants A and C coupled by a central beam 39 passing through a central region (center 35) of the gyroscope 200. Proof mass 202b may be distributed over, for example, opposing quadrants B and D with portions (halves) of proof mass 202b corresponding to quadrants B and D coupled by a beam 39 running along a perimeter (an edge 37) of the gyroscope 200. Proof mass 202a may be loosely mechanically coupled to proof mass 202b by anti-phase suspension flexures 43 (in addition to central suspension flexures 23). Anti-phase suspension flexures 43 can expand or contract to elastically absorb or accommodate mechanical displacement of the proof masses toward or away from each other (e.g., in a rotational oscillation mode).

In example gyroscope 200, out-of-plane X-axis sense electrodes 27 and Y-axis sense electrodes 28 (which are disposed on via wafer 103 below device layer 105) are placed close to the center of gyroscope 200 (e.g., at about midway between center 35 and edge 37 of gyroscope 200). Further, the center-of-mass of the X-axis and Y-axis sense electrodes are placed at about the same radial distance from the center of gyroscope 200 as the four anchors (i.e., anchors 21) that attach static mass 201 to the substrate.

Gyroscope 200, as shown in FIG. 2, also includes various in-plane drive and sensing electrodes. For example, gyroscope 200 includes two pairs of drive electrodes (e.g., a first pair including an in-phase (clockwise) drive actuator 24a and an anti-phase (counter-clockwise) drive actuator 24b, and a second pair including an in-phase drive actuator 25a and an anti-phase drive actuator 25b), a pair of sensing electrodes (e.g., drive oscillation sense electrodes 26), and a pair of Z-axis rate sense electrodes 29. These in-plane and sensing electrodes are disposed at radial distances from the center of gyroscope 200 toward the outer edges (e.g., edge 37) of gyroscope 200 that are greater than the radial distances at which the out-of-plane X-axis and Y-axis sense electrodes are placed from the center of gyroscope.

Drive actuators (24a, 24b), drive actuators (25a, 25b), drive oscillation sense electrodes 26, and Z-axis rate sense electrodes 29 can, for example, be comb finger structures. Beam 39 (running along rim or edge 37 of the gyroscope), which mechanically couples quadrants B and D of proof mass 202b together, can also force Z-axis rate sense electrodes 29 to move in the same direction proof mass 202b.

In gyroscope 200, the various in-plane drive and sensing electrodes (e.g., drive actuators (24a, 24b), drive actuators (25a, 25b), drive oscillation sense electrodes 26, and Z-axis rate sense electrodes 29) are attached to the substrate (e.g., wafer 103), for example, via anchors (e.g., anchors 30).

A Z-axis rotary oscillation mode of gyroscope 200 can be actuated, for example, by using drive actuators (24a, 24b) and drive actuators (25a, 25b) to drive proof mass 202a and proof mass 202b toward each other and away from each other in a rotational oscillatory mode. Drive oscillation sense electrodes 26 can sense oscillation of dynamic mass 202 and provide feedback to a drive circuit (not shown) that drives the in-phase and anti-phase drive actuators (24a, 24b, 25a, 25b) to, for example, drive dynamic mass 202 (proof mass 202a and proof mass 202b) in the rotary oscillation mode to resonance.

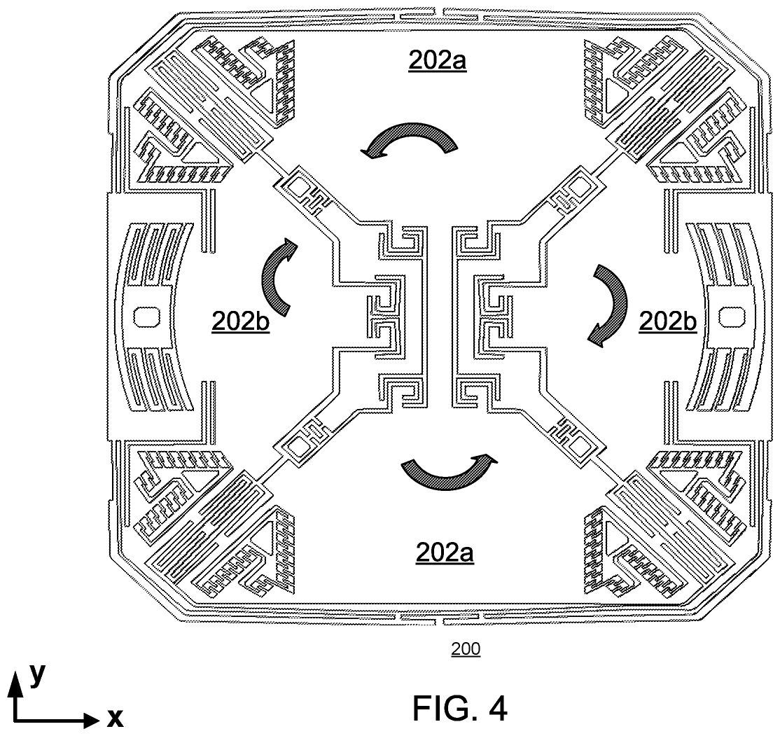

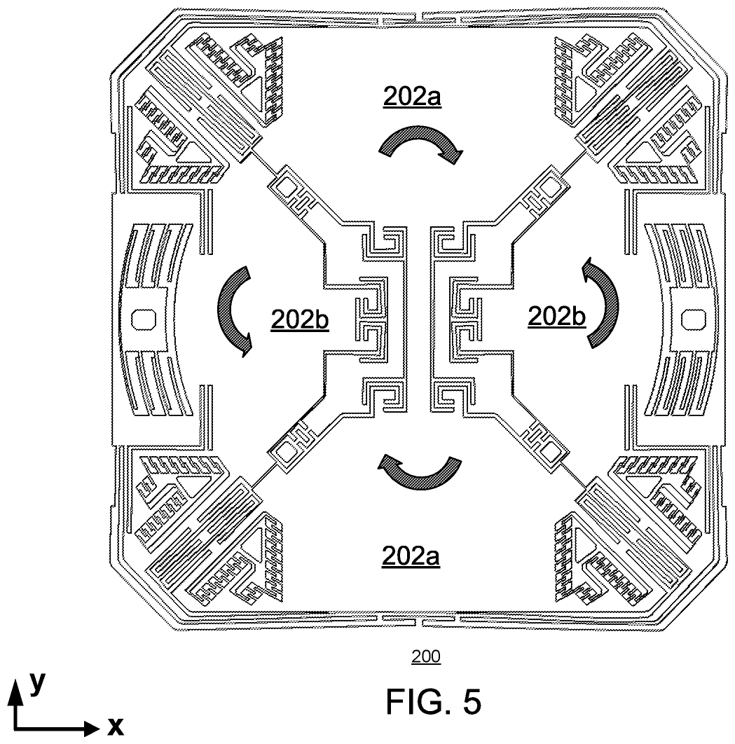

FIG. 4 shows a schematic view of a first half cycle state of counter clockwise rotation of proof mass 202a and clockwise rotation of proof mass 202b. FIG. 5 shows a schematic view of a second half cycle state of clockwise rotation of proof mass 202a and a counter clockwise rotation of proof mass 202b. The in-phase drive actuators 24a, 24b and anti-phase drive actuators 25a, 25b can be used to switch between the two half cycle states to set up an oscillatory rotational motion of the two proof masses toward and away from each other in an anti phase resonant state of a Z-axis rotary oscillation mode.

In example implementations, each of the two proof masses 202a and 202b in gyroscope 200 may have mass distributions that have equivalent magnitude displacement (i.e., equivalent contribution to angular momentum (moment of inertia x angular velocity)) when driven by the drive actuators at respective angular velocities in a resonant state of the Z-axis rotary oscillation mode. The angular momentums of the two proof masses (which rotate in opposite directions) balance and cancel each other out (so that the dynamic mass configuration has a net angular momentum of about zero) in the resonant state of the Z-axis rotary oscillation mode.

In operation, a Z-axis rotary oscillation drive on gyroscope 200 can be a high amplitude drive. The symmetric c-beam flexures, such as gyroscope central suspension flexures 23) at the center of gyroscope 200, can provide mechanical quadrature cancellation.

Further, in-plane differential comb finger electrodes for Z-axis rate sense electrodes 29 can be used to sense a Coriolis rate response (e.g., to external rotation of the gyroscope).

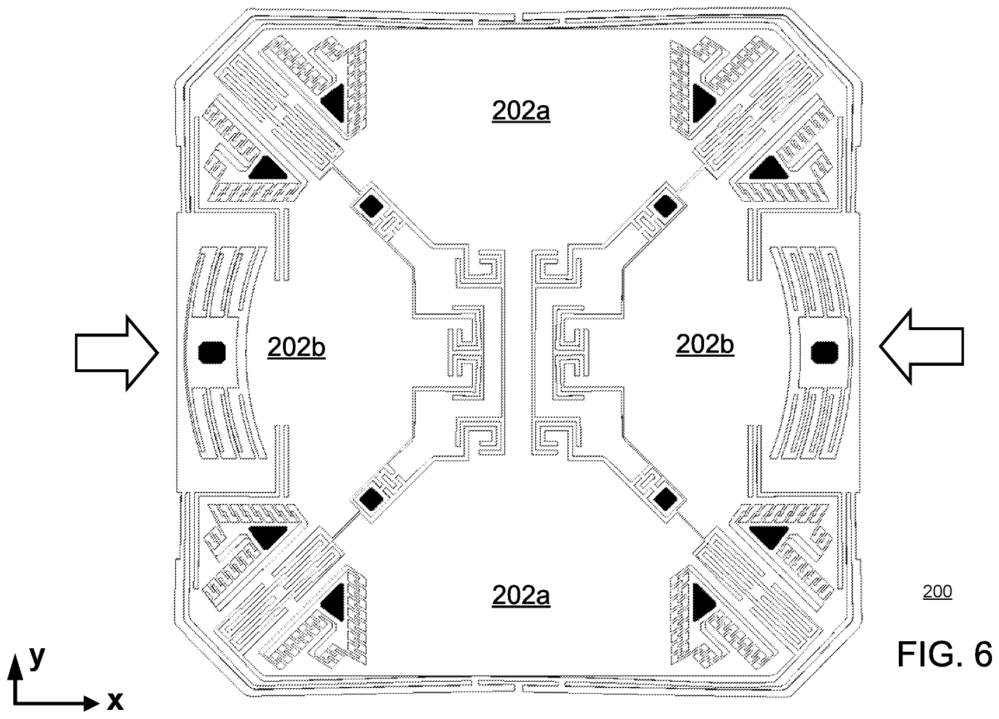

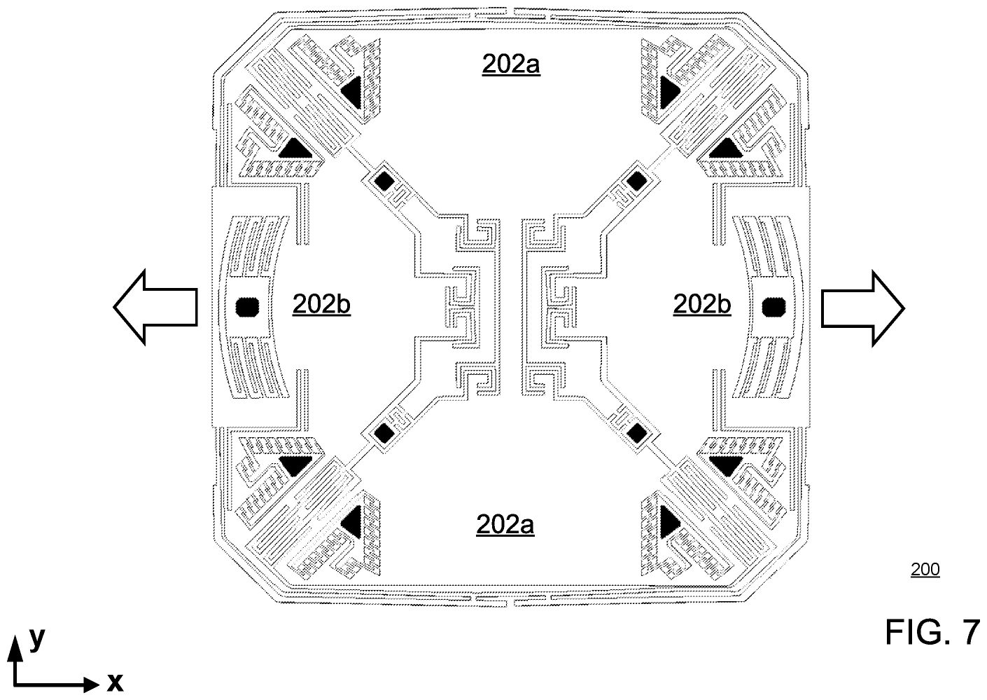

FIG. 6 shows an example of first half cycle state of Z-axis sense motion of gyroscope 200, and FIG. 7 shows an example of second half cycle of state of Z-axis sense motion of gyroscope 200. The differential capacitance as measured by the pair of Z-axis rate sense electrodes 29 is used to sense the Coriolis rate response, in accordance with the principles of the present disclosure. Further, the out-of-plane X-axis rate sense electrodes 27 (X−) and 27 (X+), and out-of-plane Y-axis rate sense electrodes 28 (Y−) and 28 (Y+) can sense the Coriolis rate response (e.g., due to tilting of gyroscope 200).

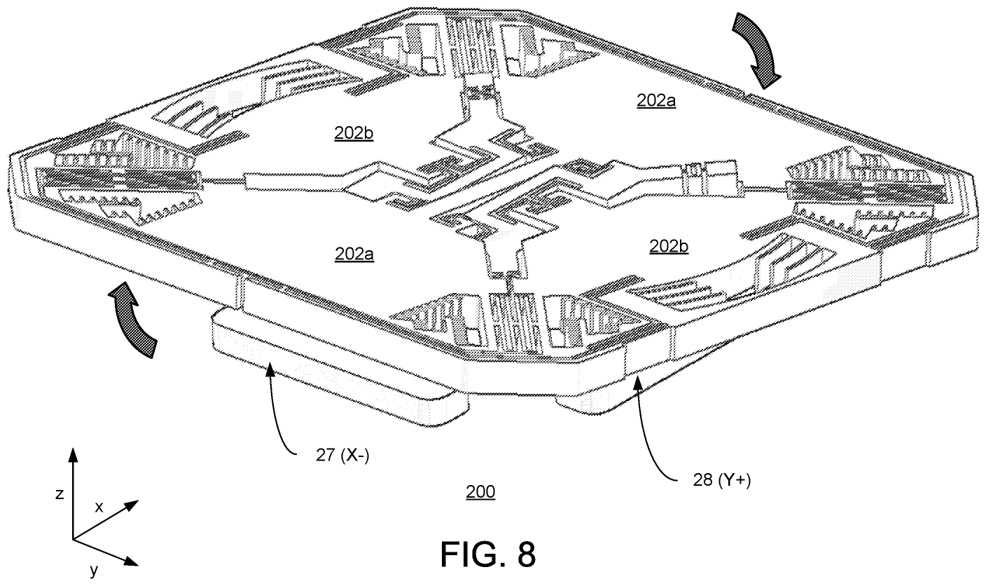

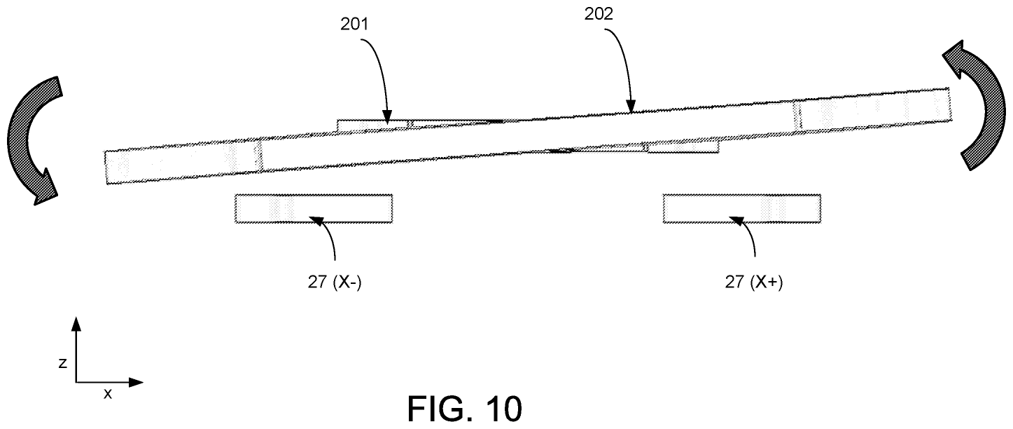

FIG. 8 shows, in perspective view, an example of first half cycle state of X-axis sense motion of gyroscope 200. The differential capacitance as measured by the pair of X-axis rate sense electrodes 27 is used to sense Coriolis rate response to X angular velocity. Further, FIG. 10 shows a cross sectional view of the torsional displacement of the gyroscope in the second half cycle state of X-axis sense motion.

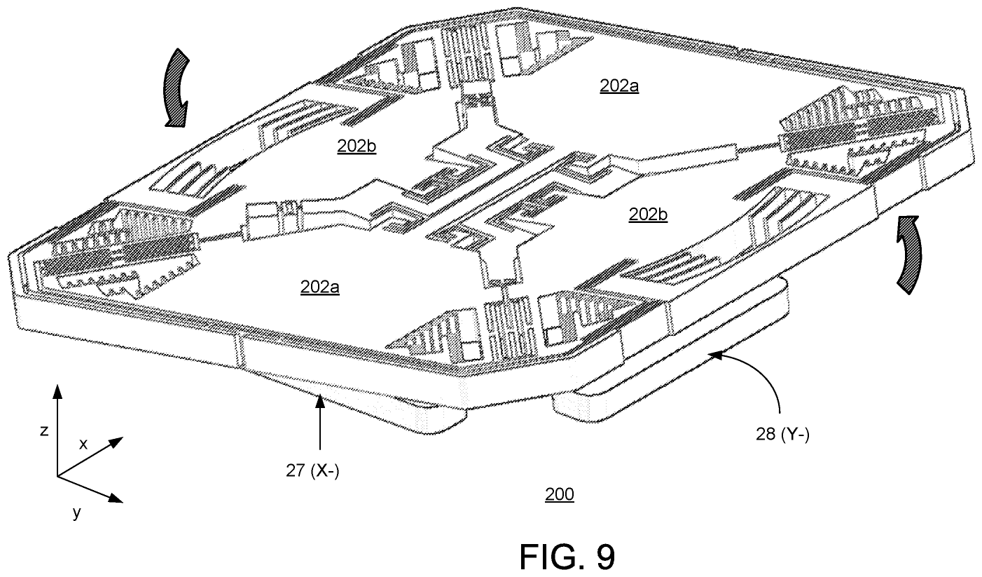

FIG. 9 shows, in perspective view, an example of first half cycle state of Y-axis sense motion of gyroscope 200. The differential capacitance as measured by the pair of Y-axis rate sense electrodes 28 is used to sense Coriolis rate response to Y angular velocity.

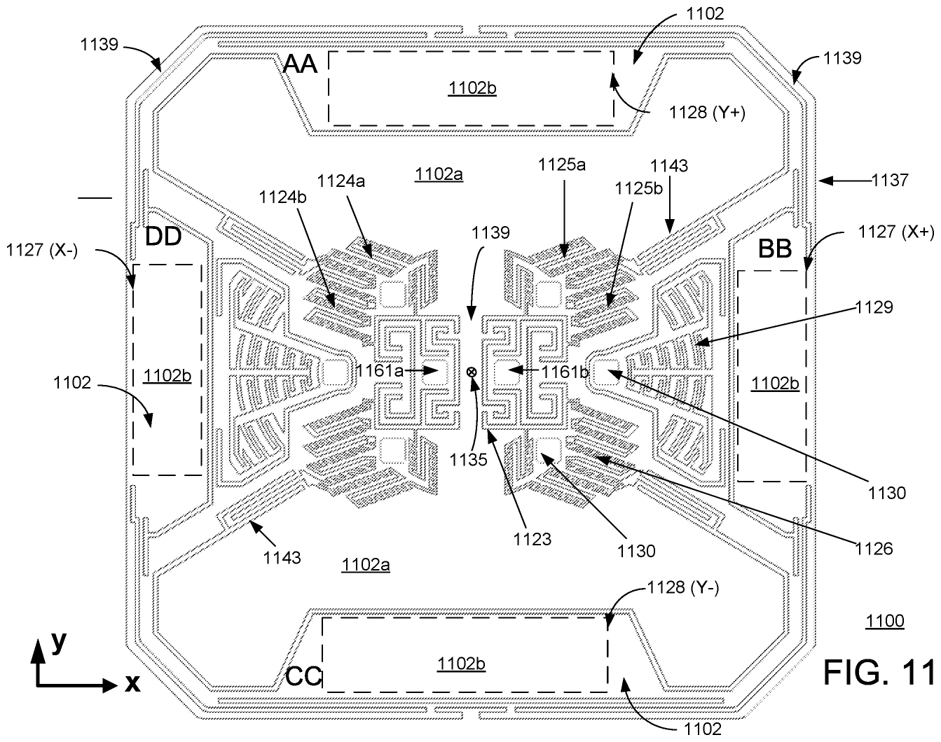

FIG. 11 shows an example gyroscope 1100 that has a second dynamic mass configuration with two proof masses and sense nodes on only one of the two proof masses, in accordance with the principles of the present disclosure.

Gyroscope 1100, which may be fabricated in a device layer (e.g., device layer 105, FIG. 1) includes a dynamic mass 1102 in the X-Y plane. Dynamic mass 1102 is supported on the substrate (e.g., wafer 13) by two anchors (e.g., anchors 1161a, 1161b) via gyroscope central suspension flexures 1123. As shown in FIG. 11, inner proof mass 1102a may have an X-shape with arms of the X shape extending, for example, from a center of gyroscope 1100 to four corners of the gyroscope. Two portions of inner proof mass 1102a (e.g., a lower half portion and an upper half portion) are coupled by a beam 1139 passing through the center region of the gyroscope.

In the gyroscope 1100, outer proof mass 1102b surrounds and is suspended from inner proof mass 1102a via gyroscope central suspension flexures 1123. Four segments or substantial material portions of outer proof mass 1102b may be distributed inward along the perimeter (e.g., edge 1137) of the gyroscope in the four valleys formed by the X-shape of inner proof mass 1102a. FIG. 11 shows, for example, four trapezoid portions AA, BB, CC, and DD of outer proof mass 1102b disposed on edge 1137 along the X axis (AA, CC) or the Y axis (BB, DD). Outer proof mass 1102b may further include a beam 1139 running along a perimeter or rim (e.g., edge 1137) of the gyroscope to connect the four trapezoid portions (AA, BB, CC and DD) of the outer proof mass.

Outer proof mass 1102b may also be loosely mechanically coupled to inner proof mass 1102b by anti-phase suspension flexures 1143 (in addition to central suspension flexures 1123). Anti-phase suspension flexures 1143 can expand or contract to elastically absorb or accommodate mechanical displacement of the inner and outer proof masses toward or away from each other (e.g., in a rotational oscillation).

Gyroscope 1100, like gyroscope 200, also includes various in-plane drive and sensing electrodes. For example, gyroscope 1100 includes two pairs of drive electrodes (e.g., a first pair including a counter-clockwise drive actuator 1124a and a clockwise drive actuator 1124b, and a second pair including an clockwise drive actuator 1125a and a counter clockwise drive actuator 1125b), a pair of sensing electrodes (e.g., drive oscillation sense electrodes 1126), and a pair of Z-axis rate sense electrodes 1129. These in-plane and sensing electrodes are disposed at radial distances that are about midway between a center 1135 and an edge 1137 of gyroscope 1100.

FIG. 11 shows, for example, that the pair of Z-axis rate sense electrodes 1129 can be disposed (along the x-axis), for example, midway between the center of the gyroscope and edge 1137. In the example shown, the pair of Z-axis rate sense electrodes 1129 are coupled to outer proof mass 1102b.

Drive actuators 1124a, 1124b, drive actuators 1125a, 1125b, drive oscillation sense electrodes 1126, and Z-axis rate sense electrodes 1129 can, for example, be comb finger structures. In gyroscope 1100, the various in-plane drive and sensing electrodes (e.g., drive actuators (1124a, 1124b), drive actuators (1125a, 1125b), drive oscillation sense electrodes 1126, and Z-axis rate sense electrodes 1129) are attached to the substrate (e.g., wafer 103), for example, via anchors (e.g., anchors 1130).

A Z-axis rotary oscillation mode of gyroscope 1100 can be actuated, for example, by using drive actuators 1124a, 1124b and drive actuators 1125a, 1125b to drive proof mass 1102a and proof mass 1102b in opposing directions in a rotational oscillatory mode. Drive oscillation sense electrodes 1126 can sense oscillation of dynamic mass 1102 and provide feedback to a drive circuit (not shown) that drives the in-phase and anti-phase drive actuators 1124a, 1124b, 1125a, 1125b to, for example, drive dynamic mass 1102 (proof mass 1102a and proof mass 1102b) in the rotary oscillation mode to resonance.

In the example gyroscope 1100, out-of-plane X-axis rate sense electrodes (i.e., electrodes 1127 (X−) and 1127(X+)) and out-of-plane Y-axis rate sense electrodes (i.e., electrodes 1128 (Y−) and 1128 (Y+)) (which are disposed on wafer 103 below device layer 105) are placed close to the outer edges of gyroscope 1100 away from the center of gyroscope 1100. These out-of-plane electrodes are disposed at distances from the center of gyroscope 1100 toward the outer edges (e.g., edge 1137) of gyroscope 1100 that are greater than the distances at which the in-plane electrodes (i.e., drive actuators (1124a, 1124b), drive actuators (1125a, 1125b), drive oscillation sense electrodes 1126, and Z-axis rate sense electrodes 1129) are placed from the center of gyroscope.

As shown in FIG. 11, the out-of-plane X-axis rate sense electrodes (i.e., electrodes 1127 (X−) and 1127(X+)) and out-of-plane Y-axis rate sense electrodes (i.e., electrodes 1128 (Y−) and 1128 (Y+) may be disposed (on wafer 103 below device layer 105) underneath the four trapezoid portions (AA, BB, CC and DD) of outer proof mass 1102b disposed on edge 1137 of the gyroscope.

A Z-axis rotary oscillation mode of gyroscope 1100 can be actuated, for example, by using drive actuator 1124a to drive inner proof mass 1102a in a counter-clockwise direction, and using drive actuator 1124b to drive outer proof mass 1102b in an opposite direction i.e., a clockwise direction. Drive actuator 1125a and drive actuator 1125b may be used to reverse the rotational directions (e.g., to drive inner proof mass 1102a in a clockwise direction, and drive outer proof mass 1102b in a counter-clockwise direction) to establish a rotary oscillation mode.

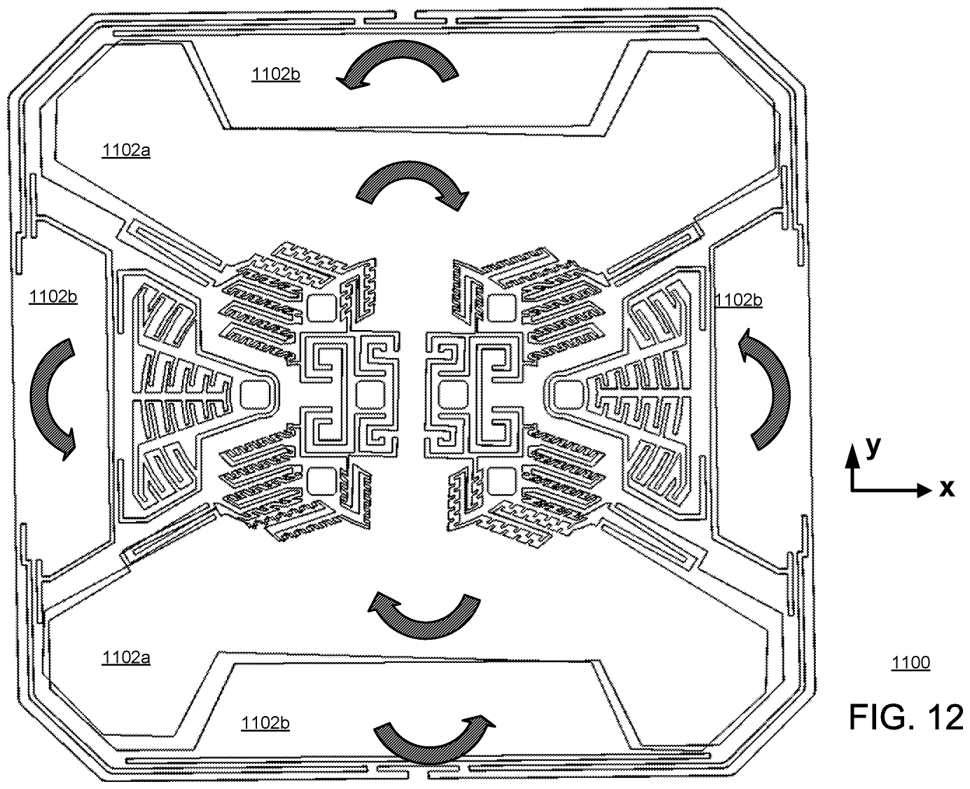

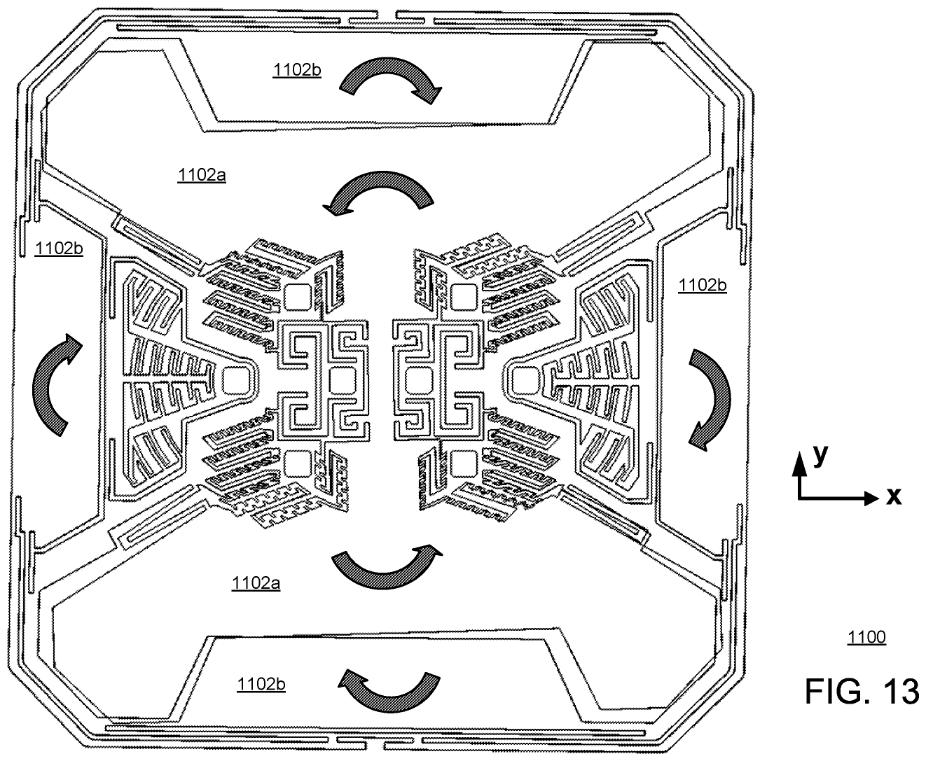

FIG. 12 shows a schematic view of a first half cycle state of clockwise rotation of inner proof mass 1102a and counter-clockwise rotation of outer proof mass 1102b. FIG. 13 shows a schematic view of a second half cycle state of counter-clockwise rotation of inner proof mass 1102a and clockwise rotation of outer proof mass 1102b. The in-phase and anti-phase drive actuators (1124a, 1124b, 1125a, 1125b) can be used to switch between the two states to set up an oscillatory rotational motion of the two proof masses toward and away from each other in a resonant state of a Z-axis rotary oscillation mode.

Drive oscillation sense electrodes 1126 can sense drive oscillation and provide feedback to a drive circuit (not shown) that drives clockwise drive actuator and counter-clockwise drive actuators.

In example implementations, each of the two proof masses 1102a and 1102b in gyroscope 1100 may have mass distributions that have equivalent magnitude displacement (e.g., equivalent contribution to angular momentum (rotational inertia x angular velocity)) when driven by the drive actuators at respective angular velocities in a resonant state of the Z-axis rotary oscillation mode. The angular momentums of the two proof masses (which rotate in opposite directions) balance and cancel each other out (so that the dynamic mass configuration has a net angular momentum of about zero) in the resonant state of the Z-axis rotary oscillation mode.

The in-plane Z-axis rate sense electrodes 1129, out-of-plane X-axis rate sense electrodes (i.e., electrodes 1127 (X−) and 1127 (X+)) and out-of-plane Y-axis rate sense electrodes (i.e., electrodes 1128 (Y−) and 1128 (Y+) can be used to sense the Coriolis rate response of gyroscope 1100 (e.g., similar to the use of Z-axis rate sense electrodes 29, out-of-plane X-axis rate sense electrodes (i.e., electrodes 27 (X−) and 27 (X+)) and out-of-plane Y-axis rate sense electrodes (i.e., electrodes 28 (Y−) and 28 (Y+) to sense the Coriolis rate response in gyroscope 200, described above with reference to FIGS. 6-10).

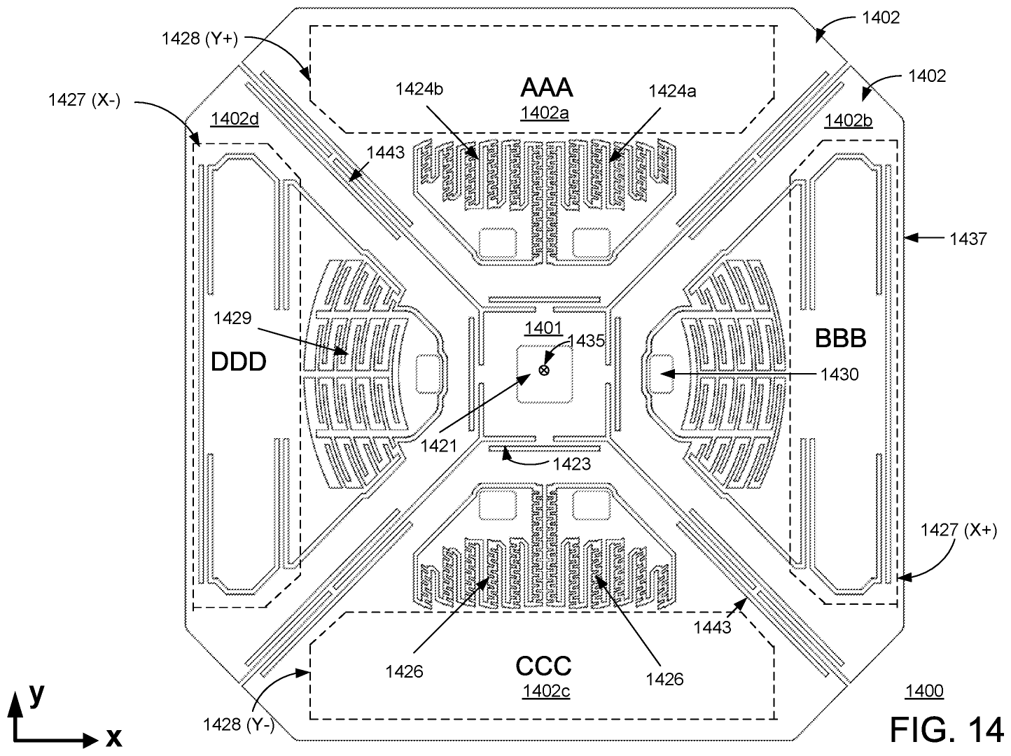

FIG. 14 shows an example gyroscope 1400 that has a third dynamic mass configuration including four independent proof masses, in accordance with the principles of the present disclosure.

Gyroscope 1400, which may be fabricated in a device layer (e.g., device layer 105, FIG. 1), includes a static mass 1401 and a dynamic mass 1402 in the X-Y plane. Dynamic mass 1402 includes independent proof masses (i.e., proof mass 1402a, proof mass 1402b, proof mass 1402c, and proof mass 1402d). Each of the four proof masses may have a wedge shape. Static mass 1401 which may, for example, have a rectangular shape (e.g., a square shape) is supported on the substrate (e.g., wafer 103).

Dynamic mass 1402 is suspended around static mass 1401 via gyroscope central suspension flexures 1423. In example implementations, flexure 22 may include one more rectangular elastic hinges 22e (e.g., as shown in FIG. 3).

Each of the four proof masses (i.e., proof mass 1402a, proof mass 1402b, proof mass 1402c, and proof mass 1402d) in dynamic mass 1402 may be suspended from a respective side or face of the square-shaped static mass 1401 via gyroscope central suspension flexures 1423, and may occupy a respective geometrical quadrant (e.g., AAA, BBB, CCC and DDD) of gyroscope 1400. Each of the four proof masses (i.e., proof mass 1402a, proof mass 1402b, proof mass 1402c, and proof mass 1402d) in its respective quadrant may be loosely mechanically coupled to the proof masses in the adjoining quadrants by anti-phase suspension flexures 1443 (in addition to central suspension flexures 1423). Anti-phase suspension flexures 1443 may expand or contract to elastically absorb or accommodate mechanical displacement of the adjoining proof masses toward or away from each other (e.g., in a rotational oscillation mode).

Gyroscope 1400, like gyroscope 200 and gyroscope 1100, also includes various in-plane drive and sensing electrodes. For example, gyroscope 1400 includes a pair of drive electrodes, for example, a clockwise drive actuator 1424a and a counter-clockwise drive actuator 1424b that are disposed in one of the four quadrants (e.g., quadrant AAA that includes proof mass 1402a) of gyroscope 1400, a pair of sensing electrodes (e.g., drive oscillation sense electrodes 1426) disposed in an opposing quadrant (e.g., quadrant CCC that includes proof mass 1402c) of gyroscope 1400. Gyroscope 1400 further includes a pair of Z-axis rate sense electrodes 1429 that are disposed in the remaining two quadrants (e.g., quadrant BBB that includes proof mass 1402b, and quadrant DDD that includes proof mass 1402d) of the gyroscope 1400. As shown in FIG. 14, these in-plane and sensing electrodes are disposed at radial distances that are about midway between a center 1435 and an edge 1437 of gyroscope 1400.

The in-plane and sensing electrodes (i.e., drive actuators (1424a, 1424b), drive oscillation sense electrodes 1426, and Z-axis rate sense electrodes 1429) can, for example, be comb finger structures. In gyroscope 1400, the various in-plane drive and sensing electrodes are attached to the substrate (e.g., wafer 103), for example, via anchors (e.g., anchors 1430).

A Z-axis rotary oscillation mode of gyroscope 1400 can be actuated, for example, by using drive actuators (1424a, 1424b) to drive adjoining proof masses (e.g., proof mass 1402a and proof mass 1402b, proof mass 1402b and proof mass 1402c, proof mass 1402c and proof mass 1402d, and proof mass 1402d and proof mass 1402a) in opposing directions in a rotary oscillation mode. Drive oscillation sense electrodes 1426 can sense oscillation of dynamic mass 1402 and provide feedback to a drive circuit (not shown) that drives the in-phase and anti-phase drive actuators 1424a, 1424b to, for example, drive dynamic mass 1402 (including the four independent proof masses—proof mass 1402a, proof mass 1402b, proof mass 1402c and proof mass 1402d) in a rotary oscillation mode to resonance.

In the example gyroscope 1400, out-of-plane X-axis rate sense electrodes (i.e., electrodes 1427 (X−) and 1427(X+)) and out-of-plane Y-axis rate sense electrodes (i.e., electrodes 1428 (Y−) and 1428 (Y+) (which are disposed on via wafer 103 below device layer 105) are placed close to the outer edges of gyroscope 1100 away from the center of gyroscope 1400. These out-of-plane electrodes are disposed at distances from the center of gyroscope 1400 toward the outer edges (e.g., edge 1137) of gyroscope 1100 that are greater than the distances at which the in-plane electrodes (e.g. drive actuators (1424a, 1124b), drive oscillation sense electrodes 1126, and Z-axis rate sense electrodes 1429) are placed from the center of gyroscope.

As shown in FIG. 14, the out-of-plane X-axis rate sense electrodes 1427 (X−) and 1427(X+), and out-of-plane Y-axis rate sense electrodes 1428 (Y−) and 1128 (Y+) may, for example, be disposed (on wafer 103 below device layer 105) underneath the wedge shaped proof masses (1402a, 1402b, 1402c, and 1402d) near edge 1437 of the gyroscope.

A Z-axis rotary oscillation mode of gyroscope 1400 can be actuated, for example, by using in-phase (clockwise) drive actuator 1424a and anti-phase drive actuator 1124b to drive adjoining pairs of the four independent proof masses 1402a, 1402b, 1402c and 1402d in opposite directions to establish the rotary oscillation mode.

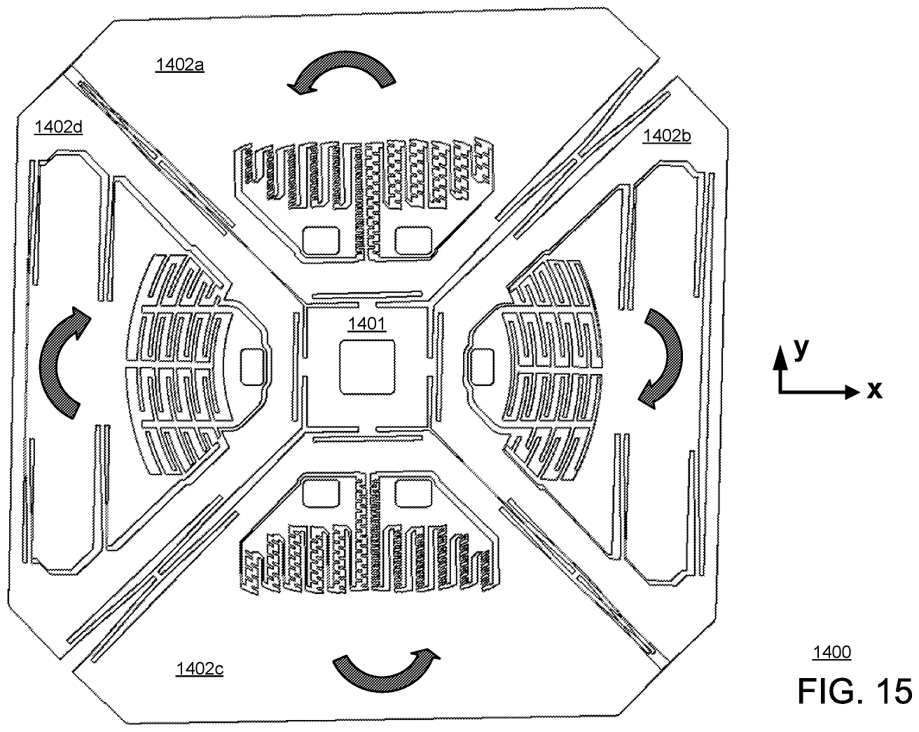

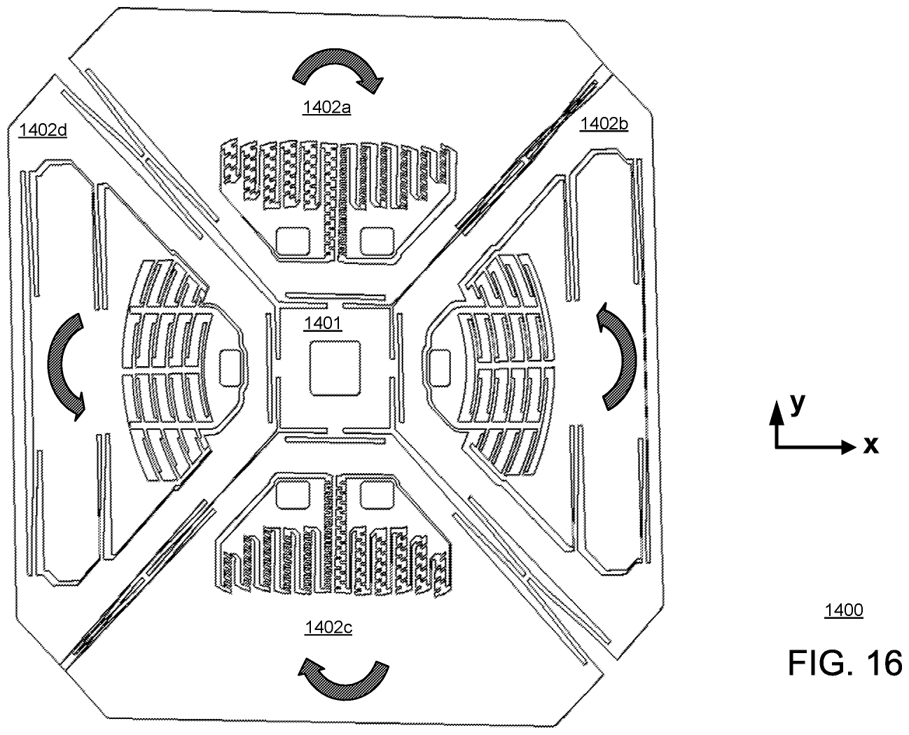

FIG. 15 shows a schematic view of a first state of rotations of the four independent proof masses 1402a, 1402b, 1402c and 1402d about static mass 1401. As shown in FIG. 15, in this first state, proof masses 1402a and proof mass 1402c rotate in a counter-clockwise direction, and proof masses 1402c and proof mass 1402d rotate in a clockwise direction. FIG. 16 shows a schematic view of a second state of rotations of the four independent proof masses 1402a, 1402b, 1402c and 1402d about static mass 1401. As shown in FIG. 16, in this second state, proof masses 1402a and proof mass 1402c rotate in a clockwise direction, and proof masses 1402b and proof mass 1402d rotate in a counter-clockwise direction. The in-phase and anti-phase drive actuators 1424a, 1424b can be used to switch between the two states to set up an oscillatory rotational motion of adjoining pairs of the four proof masses toward and away from each other to establish a resonant state of the Z-axis rotary oscillation mode.

Drive oscillation sense electrodes 1426 can sense drive oscillation of gyroscope 1400 and provide feedback to a drive circuit (not shown) that drives the in-phase and anti-phase drive actuators 1424a, 1424b.

In example implementations, each of the four proof masses 1402a, 1402b, 1402c and 1402d in gyroscope 1400 may have mass distributions that have equivalent magnitude displacement (e.g., equivalent contribution to angular momentum (rotational inertia x angular velocity)) when driven by the drive actuators 1424a, 1424b at respective angular velocities in a resonant state of the Z-axis rotary oscillation mode. The angular momentums of the four proof masses (adjoining pairs of which rotate in opposite directions) balance or cancel each other out (so that the dynamic mass configuration has a net angular momentum of about zero) in the resonant state of the Z-axis rotary oscillation mode.

The in-plane Z-axis rate sense electrodes 1429, out-of-plane X-axis rate sense electrodes 1427 (X−) and 1427 (X+) and out-of-plane Y-axis rate sense electrodes 1428 (Y−) and 1428 (Y+) can the used to sense the Coriolis rate response of gyroscope 1400 (e.g., in manner similar to the use of Z-axis rate sense electrodes 29, out-of-plane X-Axis rate sense electrodes 27 (X−) and 27 (X+) and out-of-plane Y-Axis rate sense electrodes 28 (Y−) and 28 (Y+) to sense the Coriolis rate response in gyroscope 200, described above with reference to FIGS. 6-10).

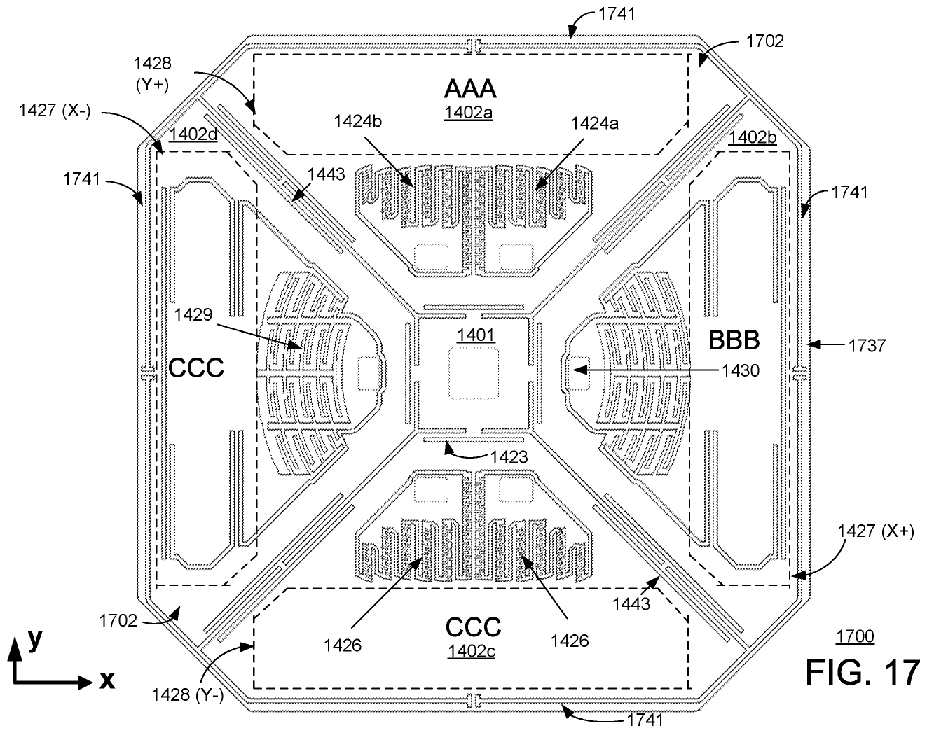

FIG. 17 shows an example gyroscope 1700 that has a fourth dynamic mass configuration including four independent proof masses, in accordance with the principles of the present disclosure.

Gyroscope 1700, like gyroscope 1400, may include a static mass 1401 and a dynamic mass 1702 in the X-Y plane. Dynamic mass 1702, like dynamic mass 1402, includes four wedge-shape independent proof masses, proof mass 1402a, proof mass 1402b, proof mass 1402c, and proof mass 1402d, that are suspended around static mass 1401 via gyroscope central suspension flexures 1423. Dynamic mass 1702 may further include a reinforcement beam 1741 running along a perimeter or rim (e.g., edge 1737) of the gyroscope to connect the four wedge-shape independent proof masses (i.e., proof mass 1402a, proof mass 1402b, proof mass 1402c, and proof mass 1402d). Reinforcement beam 1741 may add inertia to each of the four proof masses equivalently and may stiffen one or more undesirable resonance modes of gyroscope 1700.

Gyroscope 1700, like gyroscope 1400, also includes various in-plane drive and sensing electrodes. For example, gyroscope 1700 includes a pair of drive electrodes including a clockwise drive actuator 1424a and a counter-clockwise drive actuator 1424b that are disposed in one of the four quadrants (e.g., quadrant AAA that includes proof mass 1402a) of the gyroscope, a pair of sensing electrodes (e.g., drive oscillation sense electrodes 1126) disposed in an opposing quadrant (e.g., quadrant CCC that includes proof mass 1402c) of the gyroscope. Gyroscope 1700 further includes a pair of Z-axis rate sense electrodes 1429 that are disposed in the remaining two quadrants (e.g., quadrant BBB and quadrant CCC) of the gyroscope.

As for gyroscope 1400 discussed above, a Z-axis rotary oscillation mode of gyroscope 1700 can be actuated, for example, by using drive actuators 1424a, 1424b to drive adjoining proof masses (e.g., proof mass 1402a and proof mass 1402b, proof mass 1402b and proof mass 1402c, proof mass 1402c and proof mass 1402d, and proof mass 1402dc and proof mass 1402a) in opposing directions in a rotational oscillatory mode.

As in gyroscope 1400, each of the four proof masses 1402a, 1402b, 1402c and 1402d in gyroscope 1700 may have masses that have equivalent magnitude displacement when driven by the drive actuators. The angular momentums of the four proof masses (adjoining pairs of which rotate in opposite directions) balance or cancel each other out. Reinforcement beam 1741, which adds inertia to each of the four proof masses equivalently, may suppress one or more undesirable resonance modes of gyroscope 1700.

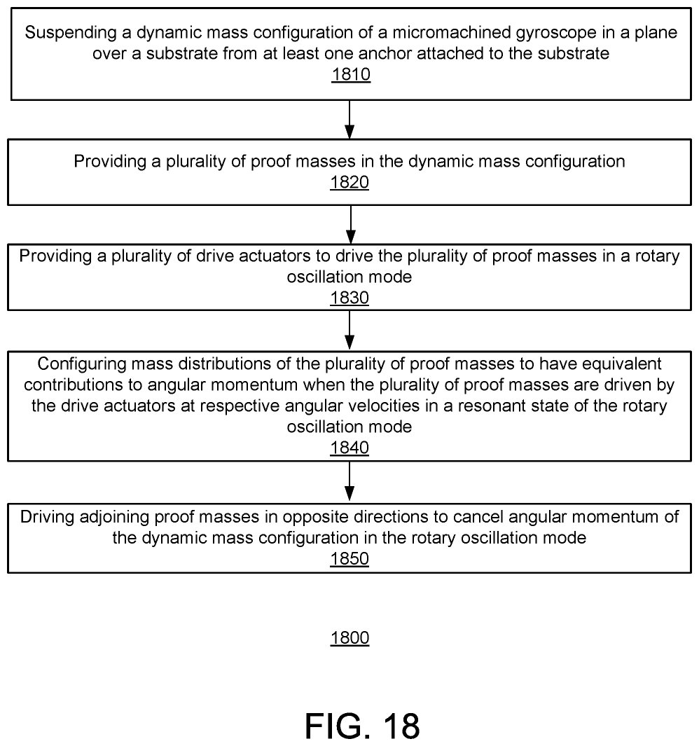

FIG. 18 shows an example method 1800 for balancing angular momentum of proof masses in a micromachined gyroscope.

Method 1800 includes suspending a dynamic mass configuration of a micromachined gyroscope in plane (e.g., an x-y plane) over a substrate from at least one anchor attached to the substrate (1810).

Method 1800 may further include providing a plurality of proof masses in the dynamic mass configuration (1820), providing a plurality of drive actuators to drive the plurality of proof masses in a rotary oscillation mode (e.g., a Z-axis rotary oscillation mode) of the gyroscope (1830), configuring mass distributions of the plurality of proof masses to have equivalent contributions to angular momentum of the dynamic mass configuration when the plurality of proof masses are driven by the drive actuators at respective angular velocities in a resonant state of the rotary oscillation mode (1840), and driving adjoining proof masses in opposite directions to cancel angular momentum of the dynamic mass configuration in the rotary oscillation mode (1850).

In method 1800, providing a plurality of proof masses in the dynamic mass configuration (1820) may include providing anti-phase suspension flexures to couple pairs of adjoining proof masses. The anti-phase suspension flexures may expand or contract to elastically absorb or accommodate mechanical displacement of the adjoining proof masses toward or away from each other (e.g., in a rotational oscillation).

It will also be understood that when an element, such as a transistor or resistor, or gyroscope component, is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element or layer, there are no intervening elements or layers present. Although the terms directly on, directly connected to, or directly coupled to may not be used throughout the detailed description, elements that are shown as being directly on, directly connected or directly coupled can be referred to as such. The claims of the application (if included) may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

Implementations of the various techniques described herein may be implemented in (e.g., included in) digital electronic circuitry, or in computer hardware, firmware, software, or in combinations of them. Portions of methods also may be performed by, and an apparatus may be implemented as, special purpose logic circuitry, e.g., an FPGA (field programmable gate array) or an ASIC (application-specific integrated circuit).

Implementations may be implemented in a computing system that includes an industrial motor driver, a solar inverter, ballast, a general-purpose half-bridge topology, an auxiliary and/or traction motor inverter driver, a switching mode power supply, an on-board charger, an uninterruptible power supply (UPS), a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that claims, if appended, are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A micromachined gyroscope comprising:
a substrate;
a dynamic mass suspended from at least one anchor attached to the substrate, the dynamic mass including a first proof mass and a second proof mass;
a first drive actuator configured to drive the first proof mass in a direction in a rotary oscillation mode of the gyroscope; and
a second drive actuator configured to drive the second proof mass in an opposite direction in the rotary oscillation mode of the gyroscope.

2. The micromachined gyroscope of claim 1, wherein the first proof mass and the second proof mass are coupled by anti-phase suspension flexures that expand and contract to accommodate mechanical displacement of the proof masses toward and away from each other.

3. The micromachined gyroscope of claim 1, wherein a first portion of the first proof mass is distributed over a first quadrant and a second portion of the first proof mass is distributed over a third opposing quadrant of the gyroscope, and wherein a beam passing through a central region of the gyroscope connects the first portion and the second portion of the first proof mass.

4. The micromachined gyroscope of claim 1, wherein a first portion of the second proof mass is distributed over a second quadrant, and a second portion of the second proof mass is distributed over a fourth opposing quadrant of the gyroscope, and wherein a beam along an edge of the gyroscope connects the first portion and the second portion of the second proof mass.

5. The micromachined gyroscope of claim 1 further comprising:
one or more out-of-plane sense electrodes disposed on the substrate and configured to detect X-axis and Y-axis acceleration of the dynamic mass.

6. The micromachined gyroscope of claim 5, wherein the one or more out-of-plane sense electrodes configured to detect X-axis and Y-axis acceleration of the dynamic mass are disposed on the substrate midway between a center of the gyroscope and an edge of the gyroscope.

7. The micromachined gyroscope of claim 6, wherein the first drive actuator, the second drive actuator, and a drive sensing electrode are disposed in-plane of the dynamic mass toward an edge of the gyroscope at distances from the center of the gyroscope that are greater than the distances at which the one or more out-of-plane sense electrodes are disposed.

8. The micromachined gyroscope of claim 1, wherein the first proof mass has an X-shape with arms of the X shape extending from a center of the gyroscope to four corners of the gyroscope.

9. The micromachined gyroscope of claim 8, wherein the second proof mass is suspended from the first proof mass via gyroscope central suspension flexures, the second proof mass having four segments distributed inward from an edge of the gyroscope in the four valleys formed by the X shape of the first proof mass, and wherein the second proof mass further includes a beam along the edge of the gyroscope connecting the four segments of the second proof mass.

10. The micromachined gyroscope of claim 9, wherein the first drive actuator, the second drive actuator, and a drive sensing electrode are disposed in-plane of the dynamic mass midway between a center of the gyroscope and an edge of the gyroscope.

11. The micromachined gyroscope of claim 10 further comprising:
one or more out-of-plane sense electrodes configured to detect X-axis and Y-axis acceleration of the dynamic mass, the one or more out-of-plane sense electrodes being disposed on the substrate toward an edge of the gyroscope.

12. A micromachined gyroscope comprising:
a substrate;
a static mass anchored to the substrate; and
a dynamic mass including a first wedge-shape proof mass, a second wedge-shape proof mass, a third wedge-shape proof mass, and a fourth wedge-shape proof mass, each of the four wedge-shape proof masses distributed over a respective quadrant of the gyroscope and suspended from the static mass by gyroscope central suspension flexures.

13. The micromachined gyroscope of claim 12, wherein each of the wedge-shape proof mass is coupled to adjoining wedge-shape proof masses by anti-phase suspension flexures that expand and contract to accommodate mechanical displacements of the proof masses toward and away from each other.

14. The micromachined gyroscope of claim 13, wherein a first drive actuator and a second drive actuator are disposed on the first wedge-shape proof mass, the first drive actuator and the second drive actuator configured to drive the first wedge-shape proof mass toward and away from adjoining wedge-shape proof masses in a rotary oscillation mode of the gyroscope.

15. The micromachined gyroscope of claim 14, wherein a drive sensing electrode is disposed on the third wedge-shape proof mass in a quadrant opposite the first wedge-shape proof mass.

16. The micromachined gyroscope of claim 14 further comprising:
one or more out-of-plane sense electrodes configured to detect X-axis and Y-axis acceleration of the dynamic mass, the one or more out-of-plane sense electrodes being disposed on the substrate toward an edge of the gyroscope.

17. The micromachined gyroscope of claim 14 further comprising:
a beam along an edge of the gyroscope connecting the four wedge-shape proof masses.

18. A method, comprising:
suspending, from at least on anchor attached to a substrate, a dynamic mass configuration of a gyroscope;
providing a plurality of proof masses in the dynamic mass configuration;
providing a plurality of drive actuators to drive the plurality of proof masses in a rotary oscillation mode of the gyroscope; and
configuring mass distributions of the plurality of proof masses to have equivalent contributions to angular momentum when the plurality of proof masses are driven by the drive actuators at respective angular velocities in a resonant state of the rotary oscillation mode.

19. The method of claim 18, wherein providing the plurality of proof masses includes coupling pairs of adjoining proof masses with anti-phase suspension flexures.

20. The method of claim 19 further comprising:
driving adjoining proof masses in opposite directions to cancel angular momentum of the dynamic mass configuration in the resonant state of the rotary oscillation mode.
